(19) United States
(12) Patent Application Publication
(10) Pub. No.: US 2019/0362068 A1
(43) Pub. Date: Nov. 28, 2019

(54) Blockchain Oracle

(71) Applicant: Binded Oracle Network Technology (Shanghai) Ltd., Shanghai City (CN)

(72) Inventor: Haozhou WANG, Shanghai City (CN)

(21) Appl. No.: 16/103,132

(22) Filed: Aug. 14, 2018

(30) Foreign Application Priority Data
May 28, 2018 (CN) 2018-10527638.9

(51) Int. Cl. G06F 21/55; H04L 9/06; H04L 29/06; G06F 21/64; G06F 7/58

(52) U.S. Cl. CPC G06F 21/55; H04L 9/0637; G06F 7/588; G06F 21/64; H04L 63/0428

(57) ABSTRACT

A blockchain oracle is provided. The blockchain oracle comprises: an intrusion prevention device and a processor in which a private key is stored; the intrusion prevention device is connected to the processor and is configured to send intrusion information to the processor when the blockchain oracle is intruded; and the processor is configured to destroy the private key when it receives the intrusion information. The disclosure alleviates the technical problem of low reliability of the blockchain oracle existing in the prior art, and achieves the technical effect of improving the reliability of the blockchain oracle.

### CROSS-REFERENCE TO RELATED APPLICATION

The present application claims priority to the Chinese patent application with the filing No. CN201810527638.9, filed with the State Intellectual Property Office on May 28, 2018 and entitled “Blockchain Oracle”, the contents of which are incorporated herein by reference in their entirety.

### BACKGROUND

### Technical Field

The present disclosure relates to the technical field of blockchain oracles, and in particular to a blockchain oracle.

### Background Art

A blockchain oracle establishes the link between a blockchain and a real-world event. The blockchain oracle connected with the blockchain refers to a data acquisition node triggering a smart contract based on data acquired from outside of the blockchain.

In practical applications, a participating user A of the smart contract can operate the blockchain oracle to falsify the acquired data by which the smart contract is to be triggered, steal a private key stored in the blockchain oracle, and use the private key to sign the falsified data, so that the smart contract trusts the falsified data. After the smart contract is triggered by the falsified data, the smart contract will perform transactions beneficial to the participating user A, resulting in low reliability of the blockchain oracle.

### SUMMARY

In view of the above, an object of the present disclosure is to provide a blockchain oracle to alleviate the technical problem of low reliability of the blockchain oracle existing in the prior art.

In a first aspect, embodiments of the present disclosure provide a blockchain oracle, wherein the blockchain oracle comprises: an intrusion prevention device and a processor in which a private key is stored; the intrusion prevention device is connected to the processor and is configured to send intrusion information to the processor when the blockchain oracle is intruded; and the processor is configured to destroy the private key when it receives the intrusion information.

In combination with the first aspect, embodiments of the present disclosure provide a first possible implementation of the first aspect, wherein a random number generator is disposed inside the processor; the random number generator is configured to generate a random number when the blockchain oracle is started up; and the processor is further configured to generate the private key according to the random number and through a preset random algorithm, and to save the private key.

In combination with the first aspect, embodiments of the present disclosure provide a second possible implementation of the first aspect, wherein the blockchain oracle further comprises a data acquisition sensor, the data acquisition sensor comprises an attribute data acquisition sensor, and a random number generator is disposed inside the processor; the random number generator is configured to generate a random number when the blockchain oracle is started up; the attribute data acquisition sensor is connected to the processor and is configured to send the acquired attribute sensing data to the processor; and the processor is further configured to receive the attribute sensing data, generate the private key according to the attribute sensing data and the random number and through a preset random algorithm, and save the private key.

In combination with the first aspect, embodiments of the present disclosure provide a third possible implementation of the first aspect, wherein the blockchain oracle further comprises a display device; the processor is further configured to encapsulate the private key using a preset communication protocol, to obtain a blockchain public address of the blockchain oracle; and the display device is connected to the processor and is configured to display the blockchain public address.

In combination with the first aspect, embodiments of the present disclosure provide a fourth possible implementation of the first aspect, wherein the processor is further configured to determine whether the attribute sensing data received at the current moment is changed compared with the attribute sensing data received last time, and to destroy the private key if the attribute sensing data received at the current moment is changed compared with the attribute sensing data received last time.

In combination with the first aspect, embodiments of the present disclosure provide a fifth possible implementation of the first aspect, wherein the blockchain oracle further comprises a communication device, and the data acquisition sensor further comprises a triggering data acquisition sensor; the communication device is connected to the processor and is configured to send, to the processor, the received smart contract address sent by a user participating in a smart contract through a mobile terminal; the triggering data acquisition sensor is connected to the processor and is configured to send acquired triggering sensing data to the processor; and the processor is further configured to send the received triggering sensing data to a location corresponding to the smart contract address.

In combination with the first aspect, embodiments of the present disclosure provide a sixth possible implementation of the first aspect, wherein the blockchain oracle is connected as a node to a blockchain system, or the blockchain oracle is connected to a common node of the blockchain system and receives data or sends data by providing the private key to the common node.

In combination with the first aspect, embodiments of the present disclosure provide a seventh possible implementation of the first aspect, wherein when the blockchain oracle is connected as a node to the blockchain system, a public ledger is saved in the processor, and the processor is further configured to destroy the public leger if receiving the intrusion information.

In combination with the first aspect, embodiments of the present disclosure provide an eighth possible implementation of the first aspect, wherein the communication device is further configured to send, to the processor, received target data type which is sent by the mobile terminal and required for triggering the smart contract; and the processor is further configured to convert the data type of the received triggering sensing data into a data type consistent with the target data type.

In combination with the first aspect, embodiments of the present disclosure provide a ninth possible implementation of the first aspect, wherein the intrusion prevention device comprises a shell intrusion-prevention device, a circuit-board intrusion-prevention device, and a chip intrusion-prevention device; the shell intrusion-prevention device is connected to the processor and is configured to send shell intrusion information to the processor when a shell of the blockchain oracle is intruded; the circuit-board intrusion-prevention device is connected to the processor and is configured to send circuit-board intrusion information to the processor when a circuit board of the blockchain oracle is intruded; the chip intrusion-prevention device is connected to the processor and is configured to send chip intrusion information to the processor when a chip of the blockchain oracle is intruded; and the processor is further configured to destroy the private key if receiving any intrusion information of the shell intrusion information, the circuit-board intrusion information and the chip intrusion information.

The embodiments of the present disclosure bring about the following beneficial effects: the embodiments of the present disclosure provide a blockchain oracle, comprising: an intrusion prevention device and a processor in which a private key is stored; the intrusion prevention device is connected to the processor and is configured to send intrusion information to the processor when the blockchain oracle is intruded; and the processor is configured to destroy the private key when it receives the intrusion information. Hence, when a user A participating in the smart contract wants to intrude into the blockchain oracle, the intrusion prevention device of the blockchain oracle sends intrusion information to the processor, and the processor destroys the private key when it receives the intrusion information. Even if the user A participating in the smart contract opens the blockchain oracle, the user cannot obtain the private key and cannot use the private key to sign the falsified data, so as to avoid the problem of low reliability of the blockchain oracle caused due to the fact that the user A participating in the smart contract steals the private key stored in the blockchain oracle and uses the private key to sign the falsified data to make the smart contract trust the falsified data and that the smart contract is made to perform transactions beneficial to the participating user A. Therefore, the technical problem of low reliability of the blockchain oracle existing in the prior art is alleviated, and the technical effect of improving the reliability of the blockchain oracle is achieved.

Additional features and advantages of the disclosure will be set forth in the description which follows, and in part will be apparent from the description, or may be learned by practice of the disclosure. The objectives and other advantages of the disclosure will be realized and attained by the structure particularly pointed out in the written description and claims hereof as well as the appended drawings.

In order that the above objects, features and advantages of the present disclosure can be more clearly understood, preferred embodiments will be described below in detail by way of example with reference to the accompanying drawings.

### BRIEF DESCRIPTION OF DRAWINGS

For illustrating the technical solutions of specific embodiments of the present disclosure or of the prior art more clearly, drawings required to be used in the description of the specific embodiments or the prior art will be introduced briefly below. It is obvious that the drawings in the following description are merely illustrative of some embodiments of the present disclosure. It would be understood by those of ordinary skill in the art that other drawings could also be obtained from these drawings without any inventive effort.

FIG. 1 is a schematic structure diagram of a blockchain oracle provided in embodiments of the present disclosure;

FIG. 2 is another schematic structure diagram of a blockchain oracle provided in embodiments of the present disclosure;

FIG. 3 is another schematic structure diagram of a blockchain oracle provided in embodiments of the present disclosure; and

FIG. 4 is another schematic structure diagram of a blockchain oracle provided in embodiments of the present disclosure.

### DETAILED DESCRIPTION OF EMBODIMENTS

In order to make the objects, technical solutions and advantages of the embodiments of the present disclosure more clear, the technical solutions of the embodiments of the present disclosure will be clearly and completely described below with reference to the drawings. It is apparent that the embodiments to be described are some, but not all of the embodiments of the present disclosure. All the other embodiments obtained by those of ordinary skill in the art in light of the embodiments of the present disclosure without inventive efforts would fall within the scope of the present disclosure as claimed.

Currently, a blockchain oracle establishes the link between a blockchain and a real-world event. The blockchain oracle connected with the blockchain refers to a data acquisition node triggering a smart contract based on data acquired from outside of the blockchain.

In practical applications, a user A participating in the smart contract can operate the blockchain oracle to falsify the acquired data by which the smart contract is to be triggered, steal a private key stored in the blockchain oracle, and use the private key to sign the falsified data, so that the smart contract trusts the falsified data. After the smart contract is triggered by the falsified data, the smart contract will perform transactions beneficial to the participating user A, resulting in low reliability of the blockchain oracle. On this basis, embodiments of the present disclosure provide a blockchain oracle, which can alleviate the technical problem of low reliability of the blockchain oracle existing in the prior art, and achieve the technical effect of improving the reliability of the blockchain oracle.

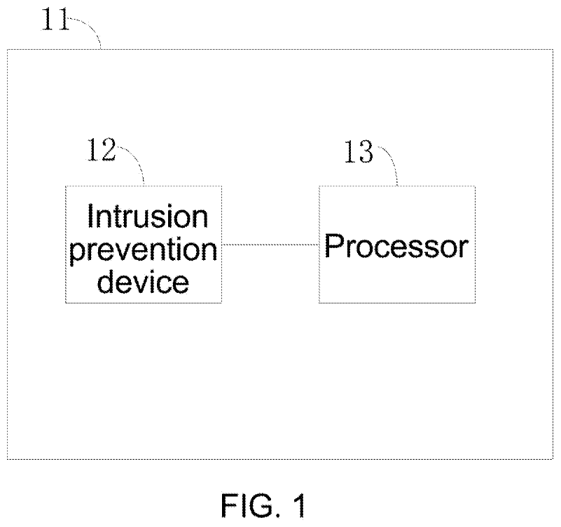

To facilitate the understanding of the present embodiment, a blockchain oracle disclosed in the embodiments of the present disclosure is first introduced in detail. As shown in FIG. 1, the blockchain oracle 11 may comprise: an intrusion prevention device 12 and a processor 13 in which a private key is stored.

The intrusion prevention device 12 is connected to the processor 13 and is configured to send intrusion information to the processor 13 when the blockchain oracle 11 is intruded.

The processor 13 is configured to destroy the private key when it receives the intrusion information.

Illustratively, the blockchain oracle 11 may comprise a power source module, the power source module is connected to the processor 13 for powering the processor 13, and the power source module may include a lithium battery.

Illustratively, the blockchain oracle 11 has unique autonomy and has the characteristic of being independent and not being controlled by a third party.

Illustratively, after the private key is destroyed, the blockchain oracle 11 may be refreshed (rooted) again. After the blockchain oracle 11 has been refreshed again, a new private key is generated in the processor 13. The new private key is different from the previous private key.

Illustratively, when the processor 13 receives the intrusion information, the private key is destroyed, but the blockchain oracle 11 itself is not destroyed, therefore the effect of repeated use of the blockchain oracle 11 is achieved.

An embodiment of the present disclosure provides a blockchain oracle 11. The blockchain oracle 11 comprises an intrusion prevention device 12 and a processor 13, wherein a private key is stored in the processor 13; the intrusion prevention device 12 is connected to the processor 13 and is configured to send intrusion information to the processor 13 when the blockchain oracle 11 is intruded; and the processor 13 is configured to destroy the private key when it receives the intrusion information. Hence, when a user A participating in the smart contract wants to intrude into the blockchain oracle 11, the intrusion prevention device 12 of the blockchain oracle 11 sends intrusion information to the processor 13, and the processor 13 destroys the private key when it receives the intrusion information. Even if the user A participating in the smart contract opens the blockchain oracle 11, the user cannot obtain the private key and cannot use the private key to sign the falsified data, so as to avoid the problem of low reliability of the blockchain oracle 11 caused due to the fact that the user A participating in the smart contract steals the private key stored in the blockchain oracle 11 and uses the private key to sign the falsified data to make the smart contract trust the falsified data and that thereby the smart contract performs transactions beneficial to the participating user A. Therefore, the technical problem of low reliability of the blockchain oracle 11 existing in the prior art is alleviated, and the technical effect of improving the reliability of the blockchain oracle 11 is achieved.

In a further embodiment of the present disclosure, a random number generator is disposed inside the processor.

The random number generator is configured to generate a random number when the blockchain oracle is started up.

The processor is further configured to generate the private key according to the random number and through a preset random algorithm, and to save the private key.

Illustratively, the private key may be randomly generated by the blockchain oracle and is confidential to any one, the private key is stored only in the blockchain oracle, and no one (including users and developers) knows the private key.

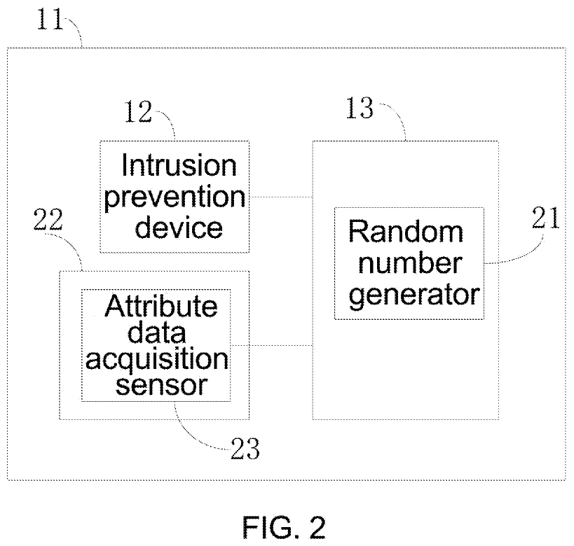

In a further embodiment of the present disclosure, as shown in FIG. 2, the blockchain oracle 11 further comprises a data acquisition sensor 22, the data acquisition sensor 22 comprises an attribute data acquisition sensor 23, and a random number generator 21 is disposed inside the processor 13.

The random number generator 21 is configured to generate a random number when the blockchain oracle 11 is started up.

The attribute data acquisition sensor 23 is connected to the processor 13 and is configured to send the acquired attribute sensing data to the processor 13.

The processor 13 is further configured to receive the attribute sensing data, generate the private key according to the attribute sensing data and the random number and through a preset random algorithm, and save the private key.

Illustratively, the attribute data acquisition sensor 23 may be a GPS (global position system) sensor, which sends the acquired geographical position data to the processor 13.

Illustratively, the participating user A of the smart contract who has an impure purpose may not directly intrude into the blockchain oracle 11 to steal the private key and falsify the acquired data by which the smart contract is to be triggered, which causes the smart contract to perform transactions beneficial to the participating user A. However, the participating user A of the smart contract may transfer the blockchain oracle 11 to another place, so that the data, which is acquired by the smart contract and by which the smart contract is to be triggered, is beneficial to his transaction.

Illustratively, there are two companies A and B. The two companies join a smart contract according to the temperature of a certain repository. The temperature of the repository is the condition for triggering the smart contract. If the temperature of the repository is greater than 100 degrees Celsius, the two companies A and B will execute a transaction over a blockchain, that is, company A will pay 1 million RMB to company B. In order to get 1 million RMB, company B may transfer the blockchain oracle 11 into any other repository at a higher temperature, so that the temperature acquired by the blockchain oracle 11 is greater than 100 degrees Celsius, thereby triggering the smart contract so as to get payment of 1 million RMB from company A. At this time, the temperature of the initial repository in which the blockchain oracle 11 is located may not be greater than 100 degrees Celsius.

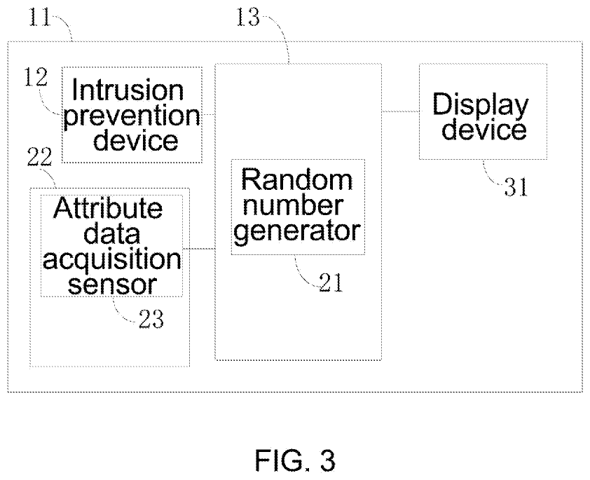

In a further embodiment of the present disclosure, as shown in FIG. 3, the blockchain oracle 11 further comprises a display device 31.

The processor 13 is further configured to encapsulate the private key using a preset communication protocol to obtain a blockchain public address of the blockchain oracle.

Illustratively, the blockchain public address is derived from the private key, and the blockchain public address may represent the identity of the blockchain oracle 11.

The display device 31 is connected to the processor 13 and is configured to display the blockchain public address.

Illustratively, the display device 31 may include devices such as LEDs (light emitting diodes) and LCDs (liquid crystal diodes).

In a further embodiment of the present disclosure, the processor is further configured to determine whether the attribute sensing data received at the current moment is changed compared with the attribute sensing data received last time, and to destroy the private key if the attribute sensing data received at the current moment is changed compared with the attribute sensing data received last time.

Illustratively, the case where the attribute sensing data is geographical position data acquired by a GPS sensor is described as an example. The attribute sensing data received last time may be geographical position data M, the attribute sensing data received at the current moment may be geographical position data N, and the private key is destroyed if the geographical position data M is different from the geographical position data N.

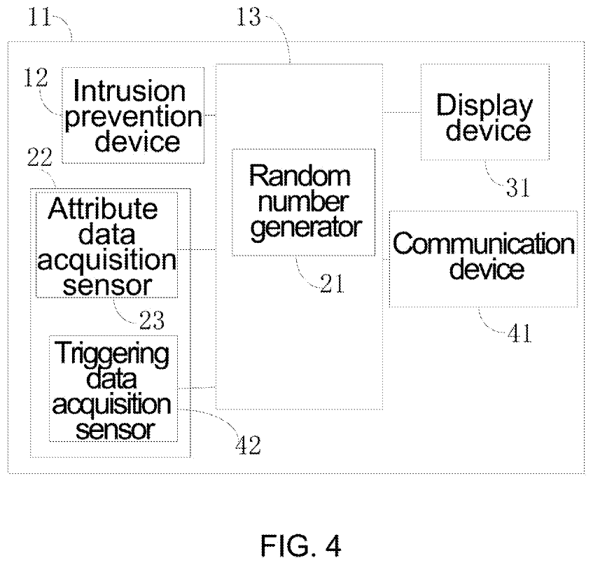

In a further embodiment of the present disclosure, as shown in FIG. 4, the blockchain oracle 11 further comprises a communication device 41, and the data acquisition sensor 22 further comprises a triggering data acquisition sensor 42.

The communication device 41 is connected to the processor 13 and is configured to send, to the processor 13, the received smart contract address sent by a user participating in a smart contract through a mobile terminal.

Illustratively, the communication device 41 may include: a WIFI communication device, a BT (Bluetooth) communication device, a LAN (local area network) communication device, a UART (universal asynchronous receiver/transmitter) communication device and the like.

The triggering data acquisition sensor 42 is connected to the processor 13 and is configured to send the triggering sensing data acquired to the processor 13.

Illustratively, the triggering data acquisition sensor 42 may include at least one of: a two-dimensional code scanner, a thermometer, a pressure gauge, and the like.

The processor 13 is further configured to send the triggering sensing data received to a location corresponding to the smart contract address.

Illustratively, the triggering sensing data may be stored on a distributed P2P network, such as an interplanetary file system (IPFS), in addition to being saved locally on the blockchain oracle 11. After the triggering sensing data is saved into the IPFS, the blockchain oracle 11 will obtain a Hash, sign the hash with the private key, and then send the signed hash to the blockchain system. In this way, the problem of high cost and low utilization rate caused by saving a large amount of data into the blockchain system is avoided, the cost of data saving is reduced, and the rate of utilization of the blockchain system is improved.

In a further embodiment of the present disclosure, the blockchain oracle is connected as a node to a blockchain system, or the blockchain oracle is connected to a common node of the blockchain system and receives data or sends data by providing the private key to the common node.

In a further embodiment of the present disclosure, when the blockchain oracle is connected as a node to the blockchain system, a public ledger is saved in the processor, and the processor is further configured to destroy the public leger if it receives the intrusion information.

Illustratively, when the blockchain oracle is connected as a node to the blockchain system, the blockchain oracle automatically saves the public ledger on the blockchain system. If a user participating in the smart contract, who has an impure purpose, steals the public ledger, privacy leakage may be caused. Hence, if the processor receives the intrusion information, the processor destroys the private key and simultaneously destroys the public ledger.

In a further embodiment of the present disclosure, as shown in FIG. 4, the communication device 41 is further configured to send, to the processor 13, the received target data type sent by the mobile terminal and required for triggering the smart contract.

The processor 13 is further configured to convert the data type of the triggering sensing data received into a data type consistent with the target data type.

Illustratively, only when the data type of the triggering sensing data is converted into a data type consistent with the target data type, the triggering sensing data can trigger the smart contract.

Illustratively, the communication device 41 may also be configured to receive the blockchain address sent by the mobile terminal and a frequency of monitoring of blockchain events, and send the blockchain address and the frequency of monitoring of blockchain events to the processor 13.

In a further embodiment of the present disclosure, the intrusion prevention device comprises a shell intrusion-prevention device, a circuit-board intrusion-prevention device, and a chip intrusion-prevention device.

Illustratively, the blockchain oracle 11 may also comprise a shell. The blockchain oracle 11 may also comprise an external memory, wherein the external memory is connected to the processor.

Illustratively, the triggering sensing data may be stored in the external memory.

The shell intrusion-prevention device is connected to the processor and is configured to send shell intrusion-information to the processor when the shell of the blockchain oracle is intruded.

Illustratively, the shell intrusion prevention device may comprise an anti-disassembled sensor and multi-way anti-detection grids.

Illustratively, the anti-disassembled sensor may be disposed between the shell and the circuit board. When the anti-disassembled sensor detects that the shell of the blockchain oracle is intruded, the anti-disassembled sensor sends shell intrusion information to the processor.

Illustratively, the anti-detection grids may be disposed between the shell and the circuit board. When the shell of the blockchain oracle is intruded, the anti-detection grids may be disconnected (open-circuited), or two groups of circuits are directly connected (short circuited) to each other. In this case, the processor will monitor such a situation and thus destroy the private key to prevent FIB (focused ion beam) detection attacks, probe attacks, DPA (differential power analysis) power attacks, and SPA (simple power analysis) power attacks.

The circuit-board intrusion-prevention device is connected to the processor and is configured to send circuit-board intrusion information to the processor when the circuit board of the blockchain oracle is intruded.

Illustratively, the circuit-board intrusion-prevention device may comprise: a security detection switch, anti-detection grids, and a security structure.

The chip intrusion-prevention device is connected to the processor and is configured to send chip intrusion information to the processor when a chip of the blockchain oracle is intruded.

Illustratively, the chip intrusion-prevention device may comprise: a core (kernel) sensor, an environmental sensor, a metal-wire mesh cover, and so on.

The processor is further configured to destroy the private key if it receives any intrusion information of the shell intrusion information, the circuit-board intrusion information, and the chip intrusion information.

The relative steps, numerical expressions, and numerical values for components and steps set forth in these embodiments do not limit the scope of the present disclosure, unless specifically stated otherwise.

The apparatus provided according to the embodiment of the present disclosure is implemented based on the same principle and creates the same technical effects as the foregoing embodiment of the method, and for parts of the embodiment of the apparatus that are not mentioned, reference can be made to corresponding disclosure in the foregoing embodiment of the method for the sake of brevity of the description.

It will be clearly appreciated by those skilled in the art that for convenience and brevity of description, specific working processes of the system and apparatus described above may be performed with reference to the corresponding processes in the foregoing embodiment of the method, and will not be described repeatedly herein.

In all examples shown and described herein, any specific value should be construed as illustrative only but not as limiting, and thus other examples of the exemplary embodiment may have different values.

It should be noted that similar reference numerals and letters refer to similar items in the following figures. Thus, once an item is defined in one figure, it may not be further defined or explained in the following figures.

The flow charts and block diagrams in the figures illustrate implementable architectures, functionalities, and operations of systems, methods and computer program products according to various embodiments of the present disclosure. In this regard, each block in the flow charts or block diagrams may represent a module, a program segment, or a portion of code, wherein the module, the program segment, or the portion of code includes one or more executable instructions for implementing specified logical function(s). It should also be noted that in some alternative implementations, the functions shown in the blocks may occur out of the order shown in the figures. For example, two blocks shown in succession may, in fact, be executed substantially in parallel, or they may sometimes be executed in a reverse order, depending upon the functionality involved. It will also be noted that each block of the block diagrams and/or flow charts, and combinations of blocks in the block diagrams and/or flow charts, may be implemented by special purpose hardware-based systems that perform the specified functions or actions, or by a combination of special purpose hardware and computer instructions.

In addition, in the description of the embodiments of the present disclosure, unless otherwise expressly specified or defined, terms “mounted”, “coupled”, and “connected” should be understood broadly. For example, connection may be fixed connection or detachable connection or integral connection, may be mechanical connection or electric connection, or may be direct coupling or indirect coupling via an intermediate medium or internal communication between two elements. The specific meanings of the above-mentioned terms in the present disclosure could be understood by those of ordinary skill in the art according to specific situations.

In the description of the present disclosure, it should be noted that orientation or positional relations indicated by the terms such as “center”, “up”, “down”, “left”, “right”, “vertical”, “horizontal”, “inside”, and “outside” are the orientation or positional relations shown based on the figures, and these terms are intended only to facilitate the description of the present disclosure and simplify the description, but not intended to indicate or imply that the referred devices or elements must be in a particular orientation or constructed or operated in the particular orientation, and therefore should not be construed as limiting the present disclosure. In addition, terms such as “first”, “second”, and “third” are used for descriptive purpose only, and should not be understood as an indication or implication of importance in relativity.

It will be clearly appreciated by those skilled in the art that, for convenience and brevity of the description, specific working processes of the system, apparatus and units described above may be performed with reference to the corresponding processes in the foregoing embodiment of the method and will not be described repeatedly herein.

In several embodiments provided in the present application, it should be understood that the disclosed system, apparatus and method may be implemented in other ways. The embodiments of the apparatus described above are merely illustrative in nature. For example, the division of the units is only by logical functions, and additional division modes may be adopted in practical implementation. For another example, multiple units or components may be combined or integrated into another system, or some features may be omitted or not executed. In addition, the mutual coupling, or direct coupling or communication connection illustrated or discussed may be implemented via indirect coupling or communication between some communication interfaces, apparatuses or units, which may be electronic, mechanical or in other forms.

The units described as separate components may be or not be separated physically, and the components illustrated as units may be or not be physical units, namely, they may be located at one place or they may be distributed onto multiple network units. Some or all of the units may be selected as actually required to fulfill the purposes of the solutions of the present embodiments.

Besides, the individual functional units in the embodiments of the present disclosure may be integrated into one processing unit, or may be physically stand-alone, or two or more of the units may be integrated into one unit.

When implemented in the form of a software functional module and sold or used as an independent product, the functions may be stored in a computer-readable storage medium. Based on such understanding, the technical solutions of the present disclosure essentially, or the part thereof contributing to the prior art, or a part of the technical solutions may be embodied in the form of a software product. The computer software product is stored in a storage medium, and includes a number of instructions for causing a computer device (which may be a personal computer, a server, a network device or the like) to execute all or some of the steps of the methods described in the various embodiments of the present disclosure. The preceding storage medium includes any medium that can store program codes, such as a USB flash disk, a mobile hard disk, a read-only memory (ROM), a random access memory (RAM), a magnetic disk, or an optical disk.

Finally, it should be noted that the embodiments described above are merely specific embodiments of the present disclosure, which are intended to illustrate the technical solutions of the disclosure and not intended to limit the disclosure, and to which the scope of protection of the disclosure is not limited. Although the present disclosure has been illustrated in detail with reference to the foregoing embodiments, it should be understood by those skilled in the art that the technical solutions described in the foregoing embodiments can be modified, or variations thereof can be readily conceived of, or some of the technical features thereof can be equivalently replaced by those skilled in the art within the technical scope disclosed in the present disclosure; and these modifications, variations or replacements do not cause the essence of the corresponding technical solution to depart from the spirit and scope of the technical solutions of the embodiments of the disclosure, and are therefore to be encompassed within the scope of protection of the present disclosure. Therefore, the scope of protection of the present disclosure is to be defined by the scope of the appended claims.

What is claimed is:

1. A blockchain oracle, comprising an intrusion prevention device and a processor, wherein a private key is stored in the processor;
the intrusion prevention device is connected to the processor and is configured to send intrusion information to the processor when the blockchain oracle is intruded; and
the processor is configured to destroy the private key when receiving the intrusion information.

2. The blockchain oracle according to claim 1, wherein a random number generator is disposed in the processor;
the random number generator is configured to generate a random number when the blockchain oracle is started up; and
the processor is further configured to generate the private key according to the random number, through a preset random algorithm, and to save the private key.

3. The blockchain oracle according to claim 1, further comprising a data acquisition sensor, wherein the data acquisition sensor comprises an attribute data acquisition sensor, and a random number generator is disposed in the processor;
the random number generator is configured to generate a random number when the blockchain oracle is started up;
the attribute data acquisition sensor is connected to the processor and is configured to send acquired attribute sensing data to the processor; and
the processor is further configured to receive the attribute sensing data, generate the private key according to the attribute sensing data and the random number, through a preset random algorithm, and save the private key.

4. The blockchain oracle according to claim 2, further comprising a display device,
wherein the processor is further configured to encapsulate the private key using a preset communication protocol, to obtain a blockchain public address of the blockchain oracle; and
the display device is connected to the processor and is configured to display the blockchain public address.

5. The blockchain oracle according to claim 4, wherein the processor is further configured to determine whether attribute sensing data received at current moment is changed compared with attribute sensing data received last time, and to destroy the private key if the attribute sensing data received at the current moment is changed compared with the attribute sensing data received last time.

6. The blockchain oracle according to claim 5, further comprising a communication device, wherein the data acquisition sensor further comprises a triggering data acquisition sensor;
the communication device is connected to the processor and is configured to send, to the processor, a received smart contract address sent by a user participating in a smart contract through a mobile terminal;
the triggering data acquisition sensor is connected to the processor and is configured to send acquired triggering sensing data to the processor; and
the processor is further configured to send the received triggering sensing data to a location corresponding to the smart contract address.

7. The blockchain oracle according to claim 6, wherein the blockchain oracle is connected, as a node, to a blockchain system, or the blockchain oracle is connected to a common node of the blockchain system, and receives data or sends data, by providing the private key to the common node.

8. The blockchain oracle according to claim 7, wherein when the blockchain oracle is connected, as a node, to the blockchain system, a public ledger is saved in the processor, and the processor is further configured to destroy the public leger if receiving the intrusion information.

9. The blockchain oracle according to claim 8, wherein the communication device is further configured to send, to the processor, received target data type, which is sent by the mobile terminal and required for triggering the smart contract; and
the processor is further configured to convert the data type of the received triggering sensing data into a data type consistent with the target data type.

10. The blockchain oracle according to claim 9, wherein the intrusion prevention device comprises a shell intrusion-prevention device, a circuit-board intrusion-prevention device, and a chip intrusion prevention device;
the shell intrusion prevention device is connected to the processor and is configured to send shell intrusion information to the processor when a shell of the blockchain oracle is intruded;
the circuit board intrusion-prevention device is connected to the processor and is configured to send circuit-board intrusion information to the processor when a circuit board of the blockchain oracle is intruded;
the chip intrusion-prevention device is connected to the processor and is configured to send chip intrusion information to the processor when a chip of the blockchain oracle is intruded; and
the processor is further configured to destroy the private key if receiving any intrusion information of the shell intrusion information, the circuit-board intrusion information and the chip intrusion information.

11. The blockchain oracle according to claim 3, further comprising a display device,
wherein the processor is further configured to encapsulate the private key using a preset communication protocol, to obtain a blockchain public address of the blockchain oracle; and
the display device is connected to the processor and is configured to display the blockchain public address.

12. The blockchain oracle according to claim 11, wherein the processor is further configured to determine whether attribute sensing data received at current moment is changed compared with attribute sensing data received last time, and to destroy the private key if the attribute sensing data received at the current moment is changed compared with the attribute sensing data received last time.

13. The blockchain oracle according to claim 12, further comprising a communication device, wherein the data acquisition sensor further comprises a triggering data acquisition sensor;
the communication device is connected to the processor and is configured to send, to the processor, a received smart contract address sent by a user participating in a smart contract through a mobile terminal;
the triggering data acquisition sensor is connected to the processor and is configured to send acquired triggering sensing data to the processor; and
the processor is further configured to send the received triggering sensing data to a location corresponding to the smart contract address.

14. The blockchain oracle according to claim 13, wherein the blockchain oracle is connected as a node to a blockchain system, or the blockchain oracle is connected to a common node of the blockchain system and receives data or sends data by providing the private key to the common node.

15. The blockchain oracle according to claim 14, wherein when the blockchain oracle is connected as a node to the blockchain system, a public ledger is saved in the processor, and the processor is further configured to destroy the public leger if receiving the intrusion information.

16. The blockchain oracle according to claim 15, wherein the communication device is further configured to send, to the processor, received target data type sent by the mobile terminal and required for triggering the smart contract; and
the processor is further configured to convert the data type of the received triggering sensing data into a data type consistent with the target data type.

17. The blockchain oracle according to claim 16, wherein the intrusion prevention device comprises a shell intrusion-prevention device, a circuit-board intrusion-prevention device, and a chip intrusion prevention device;
the shell intrusion prevention device is connected to the processor and is configured to send shell intrusion information to the processor when a shell of the blockchain oracle is intruded;
the circuit board intrusion-prevention device is connected to the processor and is configured to send circuit-board intrusion information to the processor when a circuit board of the blockchain oracle is intruded;
the chip intrusion-prevention device is connected to the processor and is configured to send chip intrusion information to the processor when a chip of the blockchain oracle is intruded; and
the processor is further configured to destroy the private key if receiving any intrusion information of the shell intrusion information, the circuit-board intrusion information and the chip intrusion information.
